(19) United States
(12) Patent Application Publication
(10) Pub. No.: US 2026/0127454 A1
(43) Pub. Date: May 7, 2026

(54) METHOD FOR CONSTRUCTING GEOGRAPHIC INFORMATION SYSTEM (GIS) APPLICATION SYSTEM FOR DIGITAL AGRICULTURE AND COMPUTER PROGRAM PRODUCT

(71) Applicant: Nanjing Normal University, Nanjing City (CN)

(72) Inventors: Di HU, Nanjing City (CN); Linwang YUAN, Nanjing City (CN); Guonian LV, Nanjing City (CN); Zongxiang ZHANG, Nanjing City (CN); Yihao MAN, Nanjing City (CN); Jun CHANG, Nanjing City (CN)

(21) Appl. No.: 19/282,770

(22) Filed: Jul. 28, 2025

(30) Foreign Application Priority Data
Nov. 6, 2024 (CN) 202411575081.8

(51) Int. Cl. G06N 5/022; G06F 16/29; G06Q 50/02

(52) U.S. Cl. CPC G06N 5/022; G06F 16/29; G06Q 50/02

(57) ABSTRACT

This application relates to the field of computer information processing, and provides a method for constructing a geographic information system (GIS) application system for digital agriculture, and a computer program product. The method includes: integrating a GIS function with a digital agriculture application demand, and dividing a GIS application for digital agriculture into a plurality of components based on an integration relationship; developing the components separately and constructing a digital agricultural GIS application component library; and selecting a component from the digital agricultural GIS application component library for assembling, and building a navigation module and various functional modules for the GIS application system for digital agriculture to complete construction of the GIS application system for digital agriculture. This application can adapt to various different digital agriculture application scenarios and personalized user demands.

### CROSS REFERENCE TO RELATED APPLICATION

This patent application claims the benefit and priority of Chinese Patent Application No. 202411575081.8, filed with the China National Intellectual Property Administration on Nov. 6, 2024, the disclosure of which is incorporated by reference herein in its entirety as part of the present application.

### TECHNICAL FIELD

The present disclosure relates to the field of computer information processing, and in particular, to a method for constructing a geographic information system (GIS) application system for digital agriculture and a computer program product.

### BACKGROUND

With the popularization of informatization technologies, a geographic information system (GIS) has been widely applied in many fields such as resource and environmental management, urban planning and management, emergency response and disaster management, and business and market analysis, and a GIS application system that integrates functional advantages of the GIS and specific industry demands has been established.

In the field of digital agriculture, a large number of GIS application systems have been established, including agricultural information collection and management systems, agricultural decision support systems (such as GISs for pest and disease decision-making, irrigation decision-making, agricultural pollution decision-making, and precise allocation of agricultural facilities), agricultural big data visualization systems, and the like, which provide important means for agricultural resource management decision-making and sustainable agricultural development, and play an important role in constructing the digital agriculture. Most of these systems are developed in a fixed modular manner, and lack flexibility and scalability, making it difficult to adapt to various different digital agriculture application scenarios and personalized user demands. How to improve a rapid response capability of the GIS application system to a digital agriculture application demand and better meet a personalized demand has become an urgent problem to be solved in current GIS application system for digital agricultures.

### SUMMARY

An objective of the present disclosure is to provide a method for constructing a GIS application system for digital agriculture and a computer program product, to solve a problem that an existing GIS application system is difficult to adapt to various different agricultural application scenarios and personalized user demands.

To achieve the above objective, the present disclosure provides the following technical solutions.

According to a first aspect, the present disclosure provides a method for constructing a GIS application system for digital agriculture, including:
integrating a GIS function with a digital agriculture application demand, and dividing a GIS application for digital agriculture into a plurality of components based on an integration relationship, where the GIS function includes a spatial data management function, a spatial analysis function, a visualization function, a multi-granularity spatio-temporal object management function, a geographic knowledge graph function, and a geographic model analysis function; the digital agriculture application demand includes an agricultural data management application demand, an agricultural information query application demand, an agricultural knowledge browsing application demand, an agricultural dynamic monitoring application demand, an agricultural statistical analysis application demand, and an agricultural decision support application demand; and the components include a general basic component and a business component;
developing the components separately and constructing a digital agricultural GIS application component library; and
selecting a component from the digital agricultural GIS application component library for assembling, and building a navigation module and various functional modules for the GIS application system for digital agriculture to complete construction of the GIS application system for digital agriculture.

According to a second aspect, the present disclosure provides a computer program product, including a computer program, where the computer program is executed by a processor to implement the above method for constructing a GIS application system for digital agriculture.

According to specific embodiments provided in the present disclosure, the present disclosure achieves the following technical effects:
The present disclosure integrates a GIS function with a digital agriculture application demand, and divides a GIS application for digital agriculture into a plurality of components based on an integration relationship. Not limited to a fixed modular development manner, the present disclosure adaptively performs the division to obtain digital agricultural GIS application components based on a digital agriculture application demand of a user, develops the obtained components separately, and builds a navigation module and various functional modules of a GIS application system for digital agriculture separately to construct the GIS application system for digital agriculture. This adapts to various different digital agriculture application scenarios and personalized user demands.

### BRIEF DESCRIPTION OF THE DRAWINGS

To describe the technical solutions in the embodiments of the present disclosure or in the prior art more clearly, the following briefly describes the accompanying drawings required for the embodiments. Apparently, the accompanying drawings in the following description show merely some embodiments of the present disclosure, and a person of ordinary skill in the art may still derive other accompanying drawings from these accompanying drawings without creative efforts.

FIG. 1 is a schematic flowchart of a method for constructing a GIS application system for digital agriculture according to an embodiment of the present disclosure;

FIG. 2 is a schematic architecture diagram of a digital agricultural GIS application component according to an embodiment of the present disclosure;

FIG. 3 is a schematic diagram of developing a GIS application system for digital agriculture according to an embodiment of the present disclosure; and

FIG. 4 is a schematic diagram of an interface for constructing a functional page of a GIS application system for digital agriculture according to an embodiment of the present disclosure.

### DETAILED DESCRIPTION OF THE EMBODIMENTS

The technical solutions in the embodiments of the present disclosure are clearly and completely described below with reference to the accompanying drawings in the embodiments of the present disclosure. Apparently, the described embodiments are only some rather than all of the embodiments of the present disclosure. All other embodiments obtained by a person of ordinary skill in the art based on the embodiments of the present disclosure without creative efforts shall fall within the protection scope of the present disclosure.

To make the above objectives, features, and advantages of the present disclosure more obvious and easier to understand, the present disclosure will be further described in detail below with reference to the accompanying drawings and specific implementations.

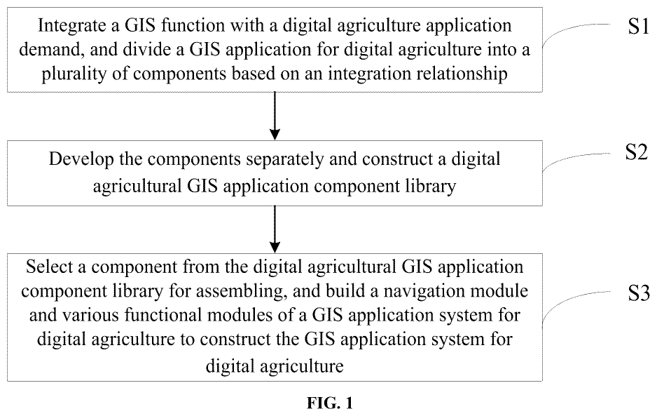

An embodiment of the present disclosure provides a method for constructing a GIS application system for digital agriculture. The method is executed by a computer device. Specifically, the method may be executed separately by the computer device such as a terminal or a server, or may be executed jointly by the terminal and the server. In this embodiment of the present disclosure, as shown in FIG. 1, the method includes the following steps:
S1: Integrate a GIS function with a digital agriculture application demand, and divide a GIS application for digital agriculture into a plurality of components based on an integration relationship, where the components are digital agricultural GIS application components; the GIS function includes a spatial data management function, a spatial analysis function, a visualization function, a multi-granularity spatio-temporal object management function, a geographic knowledge graph function, and a geographic model analysis function; the digital agriculture application demand includes an agricultural data management application demand, an agricultural information query application demand, an agricultural knowledge browsing application demand, an agricultural dynamic monitoring application demand, an agricultural statistical analysis application demand, and an agricultural decision support application demand; and the components include a general basic component and a business component.
S2: Develop the components separately and construct a digital agricultural GIS application component library.
S3: Select a component from the digital agricultural GIS application component library for assembling, and build a navigation module and various functional modules of a GIS application system for digital agriculture to construct the GIS application system for digital agriculture.

In an exemplary embodiment, the integrating a GIS function with a digital agriculture application demand is as follows:
The spatial data management function is integrated with the agricultural data management application demand to manage agricultural regional overview data, agricultural basic geographic data, agricultural thematic data, and agricultural regional socio-economic data by using a spatial database technology.
The spatial data management function is integrated with the agricultural information query application demand to spatially query agricultural information by using the spatial database technology.
The spatial data management function is integrated with the agricultural knowledge browsing application demand to manage agricultural spatial knowledge by using the spatial database technology.
The spatial data management function is integrated with the agricultural statistical analysis application demand to achieve chart statistics of agricultural thematic information.
The spatial analysis function is integrated with the agricultural decision support application demand to achieve farmland plot measurement, land planting suitability assessment, and land use planning to provide support for agricultural decision support. Further, based on precise positioning of farmlands and facilities, historical data and real-time information are comprehensively analyzed to predict a crop yield, assess a pest and disease risk, and assess a suitable crop type for planting on a land.

The visualization function is integrated with the agricultural statistical analysis application demand to make and display an agricultural thematic map.

The visualization function is integrated with the agricultural information query application demand to display a planting region and a growth situation of a crop, thereby displaying a three-dimensional agricultural scene, and scientifically and effectively manage and plan agricultural resources.

The multi-granularity spatio-temporal object management function is integrated with the agricultural information query application demand to perform entity management on an administrative region, the planting region, a plot, the crop, and other agricultural resources, construct a digital agricultural multi-granularity spatio-temporal object, and achieve agricultural object recognition and agricultural object information query. Further, each agricultural object is defined as an independent geographic entity, and object class abstraction is performed on the geographic entity from a spatio-temporal reference, a spatial location, a spatial form, a compositional structure, an association relationship, a cognitive capability, a behavioral capability, and a property to construct the digital agricultural multi-granularity spatio-temporal object.

The geographic knowledge graph function is integrated with the agricultural knowledge browsing application demand to construct and display an agricultural knowledge graph. An intelligent analysis capability of the GIS application system for digital agriculture is enhanced through agricultural knowledge management, the agricultural knowledge graph, and a function of an agricultural knowledge model.

The geographic knowledge graph function is integrated with the agricultural decision support application demand to achieve agricultural assessment and decision-making such as crop planting adaptation assessment.

The geographic model analysis function is integrated with the agricultural dynamic monitoring application demand to achieve crop parameter inversion, crop growth monitoring, and agricultural disaster monitoring.

The geographic model analysis function is integrated with the agricultural decision support application demand to achieve agricultural plot extraction, agricultural crop recognition, and planting suitability assessment.

Further, crop type recognition, crop yield estimation, the crop parameter inversion, and the like are achieved by utilizing the geographic model analysis function and integrating geographic models. In terms of the crop type recognition, decision tree, random forest, support vector machine, BP neural network, and other algorithms are used to generate an accurate crop type recognition scheme in combination with real-time data from a plurality of dimensions. The crop yield estimation adopts a multiple nonlinear regression model, which comprehensively considers a variable factor of the crop for estimation. Based on key parameters such as an NDVI, an observation environment, and a leaf structure, a crop inversion algorithm accurately simulates and infers a physiological status, a health status, and a growth dynamic of the crop.

In an exemplary embodiment, the digital agricultural GIS application components are classified into the general basic component and the business component that integrates a GIS technology with an application demand. The general basic component includes a page route container component, a page title menu component, and the like. The business component includes all components generated by integrating all GIS technologies with all application demands one by one.

A construction process of the general basic component is as follows:
Page route container component: It can dynamically display a functional page. It provides a container for displaying a page and an input form for configuring a route, which are used to display page content of the component and configure a route name.
Page title menu component: It can navigate a menu bar of a digital agricultural industry application system, and can dynamically switch content in a page route container. A navigation bar, a navigation button, and a route configuration form are provided to navigate a system page, define a page route format, and add or modify a quantity and names of functional pages in the navigation bar as needed.

Business Component:
1) The spatial data management function is integrated with the agricultural data management application demand to obtain an agricultural regional overview component and an agricultural data management component through the division.

Agricultural regional overview component: It can display information of a digital agriculture demonstration region. The regional overview component provides a text and image description of an overall agricultural overview of the region in terms of a plurality of aspects, and can switch described content.

Agricultural data management component: It has functions of browsing, querying, and downloading agricultural thematic data. Geographic data is managed through map image display and table display, and corresponding geographic data can be queried based on a keyword.

Agricultural regional location component: It can display a map animation of a location of the digital agriculture demonstration region. Through map scaling, a large-scale map is scaled and navigated to a target region, and a regional location is visually displayed on the map.
2) The spatial data management function is integrated with the agricultural information query application demand to query agricultural spatial information.

Agricultural spatial query component: It has a function of spatially querying the agricultural thematic information. Screening conditions are provided for data based on a “crop type”, “planting area”, and a “natural condition”, and then layer information with overlapping conditions is displayed on the map.
3) The spatial data management function is integrated with the agricultural knowledge browsing application demand.

Agricultural geographic knowledge management component: It has functions of browsing and querying agricultural geographic knowledge. Agricultural knowledge is summarized and displayed in a form of a table, and corresponding information is retrieved by an information querying bar.
4) The spatial analysis function is integrated with the agricultural statistical analysis application demand to obtain an agricultural spatial analysis component through the division.

Agricultural spatial analysis component: It can spatially analyze the agricultural thematic information. Three analysis methods are provided: “overlay analysis”, “terrain analysis”, and “contiguous cropland analysis”. A corresponding analysis parameter is set after a method is set, and finally a spatial analysis result is displayed on the map.
5) The spatial analysis function is integrated with the agricultural decision support application demand to obtain an agricultural spatial decision support component through the division.

Agricultural spatial decision support component: It can display corresponding different types of agricultural policies based on a layer of an existing agricultural planting region, and demonstrate implementation effects of the agricultural policies.
6) The visualization function is integrated with the agricultural information management application demand to obtain an agricultural regional location map component and an agricultural three-dimensional scene component through the division.

Agricultural three-dimensional scene component: It can display three-dimensional scenes from an agricultural region to a plot, including multi-granularity spatio-temporal object information of various levels of scenes.
7) The visualization function is integrated with the agricultural statistical analysis application demand to obtain an agricultural thematic map component through the division to implement a function of an agricultural thematic map.

Agricultural thematic map component: It can display a map with the agricultural thematic information. The agricultural thematic map component classifies the agricultural thematic map, provides selection boxes for map setting and indicator setting, and visualizes a custom thematic layer.
8) A multi-granularity spatio-temporal object management technology of GIS is integrated with the agricultural information query application demand to recognize, query, and display agricultural object information.

Agricultural object recognition component: It can recognize the agricultural object based on the map and display a map information window. After an object tool is selected as needed, layer property information is displayed in a corresponding data layer through a pop-up window.

Agricultural object space component: It establishes agricultural object space level by level based on a tree structure of the agricultural object by referring to a spatial data management method and a multi-granularity spatio-temporal object management method. The agricultural object space component can display a tree structure of the agricultural object space and display information of an agricultural multi-granularity spatio-temporal object. Plot objects are graded layer by layer in a form of a tree diagram based on a China-provincial-city level-county level-township level-plot grading method. Information of each level of object is described and displayed in terms of the “spatio-temporal reference”, the “spatial location”, the “spatial form”, the “compositional structure”, the “association relationship”, the “cognitive capability”, the “behavioral capability”, and the “property”.
9) The geographic knowledge graph function is integrated with the agricultural knowledge browsing application demand to display a knowledge relationship between objects.

Agricultural geographic knowledge graph component: It can display a graph of the agricultural geographic knowledge. The knowledge relationship between the objects is displayed as needed to generate a corresponding knowledge graph, for example, a growth condition of a potato.
10) The geographic model analysis function is integrated with the agricultural dynamic monitoring application demand to calculate different types of parameters and results to dynamically monitor an agricultural parameter, a crop growth, an agricultural disaster, a crop yield, and the like.

Agricultural parameter inversion component: It can invert an agricultural crop parameter by using a physical model based on a remote sensing image and a basic agricultural parameter.

Crop growth monitoring component: It can analyze the crop growth and display a result based on the remote sensing image and a range defined by common vegetation indicators.

Agricultural disaster monitoring component: It can recognize a planting region beyond a suitable range based on meteorological data such as a precipitation, a temperature, and a wind speed of a selected date and a suitable condition for the crop growth, and display and analyze agricultural disaster monitoring information.

Crop yield estimation component: It can estimate the crop yield and display a result by using a calculation model based on crop growth data.
11) The geographic model analysis function is integrated with the agricultural decision support application demand to obtain an agricultural plot extraction component, a crop type recognition component, and a planting suitability assessment component through the division. Based on analysis and calculation capabilities of a geographic model, massive and high-precision processing is supported for agricultural data, and assessment and decision-making of planting suitability of different crops are supported.

Agricultural plot extraction component: It can extract an agricultural plot by using a visual depth model based on the remote sensing image, and convert extracted raster data into vector data and display a result.

Crop type recognition component: It can recognize a crop type and display a result by using a classification algorithm of machine learning based on the remote sensing image and spectral and texture characteristics of the crop.

Planting suitability assessment component: It can analyze planting suitability for different crop types and natural conditions, and display a result. The crop type such as a rice, a corn, or a potato for which suitability assessment needs to be performed is selected. Based on assessment indicators including a terrain, a water content, light, and the like, as well as a specified growth condition threshold, a planting suitability result is determined, and a planting suitability layer is finally displayed on the map.

In an exemplary embodiment, the developing the components separately and constructing a digital agricultural GIS application component library specifically includes:
researching and developing an interface layout of each component through front-end secondary encapsulation, and constructing the digital agricultural GIS application component library, where an Element UI is used to process basic elements of the component, and ECharts is used to process chart elements of the component, and OpenLayers is used to process map elements of the component.

Further, each component of the GIS application for digital agriculture is developed based on a low-code development platform. The low-code development platform can complete the interface layout of each component in the GIS application for digital agriculture, and configure data and functional services.

The components of the GIS application for digital agriculture are developed separately, and have consistent interfaces and operational logic.

The interface layout of each component is developed through the front-end secondary encapsulation. The basic element of the component is processed by using the Element UI, and the Element UI contains built-in common interface elements such as an input box, a timeline, and a list selection. The chart element is processed by using the ECharts, and the ECharts includes common chart visualization scenes. The map element is processed by using the Openlayers, and the Openlayers supports common demands of a WebGIS such as map display, spatial query, and overlay analysis.

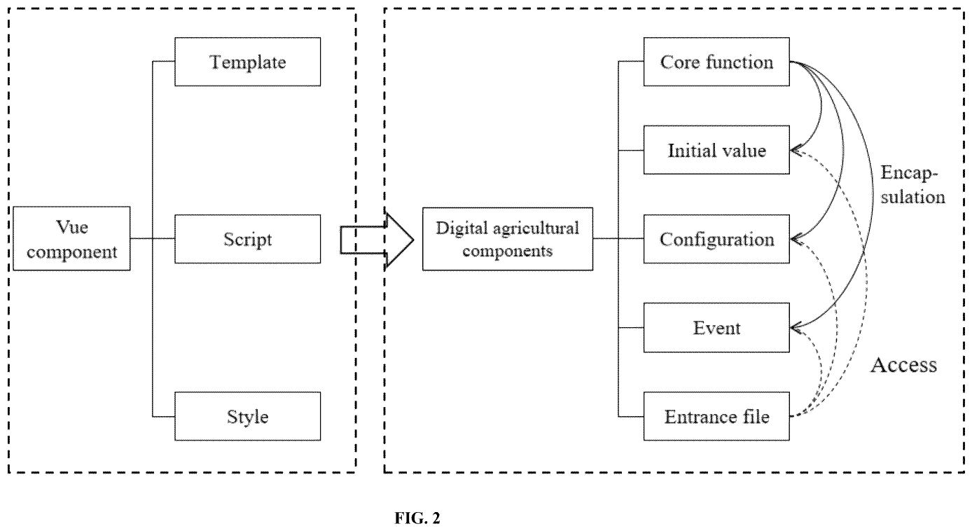

That the components have consistent interfaces and operational logic means that:
For a single component, the present disclosure further encapsulates code of a digital agriculture component based on code encapsulation of a Vue component, and divides a component development framework into five core modules, as shown in FIG. 2.

The five core modules are respectively implemented through five core files. After subpackaging a property configuration, an initial value, and a linkage event to other modules, a core code module retains core logic of the component to implement a main function of the component. An initial value module is configured to define an initial value of a form. A configuration module allows a user to customize a configuration property of the component to generate the form. An event module defines a linkage event and method of the component to ensure interactivity of the component. An entrance file module packages a relevant event, property, and initial value of the component and exports them in a modular manner.

Configuring the data and functional services is to divide a network service in the GIS application for digital agriculture into granular data and functional services. Firstly, a RESTful interface for a sub-service is designed in the data and functional services, and a function is packaged as an OGC Processes API service. A containerization technology is used to construct a digital agriculture micro-service, and a geographic analysis model and an algorithm program in digital agriculture are containerized.

In an exemplary embodiment, the GIS application system for digital agriculture includes the navigation module and the functional modules. In this embodiment, the navigation module includes a title route menu and the page route container, and the functional module is a functional page that includes the business component.

When a button of a corresponding functional page in a navigation bar of a title route menu component is clicked, content of the corresponding functional page is displayed in the “page route container” component. Based on an agricultural application demand, a plurality of components provided can be used to configure the navigation bar and freely combine the functional pages.

Some components meeting the application demand is selected from the digital agricultural GIS application component library and assembled into a functional module of the GIS application system for digital agriculture, and a plurality of modules together constitute the GIS application system for digital agriculture.

In an exemplary embodiment, the building a navigation module of a GIS application system for digital agriculture specifically includes:
establishing a blank page canvas as an initial page, dragging the title route menu component to the initial page, and configuring a navigation bar menu item and a route relationship in the title route menu component; and
on an initial page of the title route menu, combining the title route menu component and the page route container component, and configuring a corresponding container name of the page route container component based on the configured route relationship.

Further, the building a navigation module of a GIS application system for digital agriculture includes the following steps:
1) Create the blank page canvas as the initial page, drag the title route menu component to the canvas, and configure the navigation bar menu item and the route relationship in a configuration item of the title route menu component. The navigation bar menu item is an index of each functional module of the GIS application system for digital agriculture, and provides a navigation button for a page of the functional module. The route relationship is a relationship between the navigation bar menu item, the functional page display container, and the functional page. That is, when a navigation menu option is selected in the system, a corresponding functional page is displayed in a designated function display container. A format of the route relationship is defined as “page container name. page name”.
2) On the initial page of the title route menu, place the title route menu component at a top of the page, drag the page route container component below the title route menu component to combine the title route menu component and the page route container component, adjust sizes of the two components to an appropriate display ratio, and input the corresponding container name in the configuration form of the page route container component based on the configured route relationship. A format of the container name is “page container name”defined in the “step 1)”.

In an exemplary embodiment, the building various functional modules of a GIS application system for digital agriculture specifically includes:
creating a blank page canvas one by one based on a quantity of the functional modules, and inputting a page name in the route relationship in a page configuration form; and dragging a digital agriculture component of a corresponding function based on a function implementation requirement of the functional module, where the digital agriculture component is the business component.

Further, the building various functional modules of a GIS application system for digital agriculture includes the following steps:
1) Create the blank page canvas, and input the page name in the route relationship in the page configuration form. A format of the page name is “page name” defined in the “step 1)” in building the navigation module.
2) Perform a drag operation on the blank page canvas where the route name has been configured to implement the digital agricultural GIS application business component required by the corresponding function, adjust a size of the component to an appropriate display size, and complete a custom form configuration of the component. For a functional module that requires collaboration of a plurality of components, the required components are dragged together onto the canvas, and are adjusted to an appropriate size ratio.
3) For each functional module in the GIS application system for digital agriculture, repeat the above steps to build a plurality of functional module pages of the system, which form, together with the initial page, the GIS application system for digital agriculture.

The present disclosure further provides a specific application scenario to describe the method for constructing a GIS application system for digital agriculture.

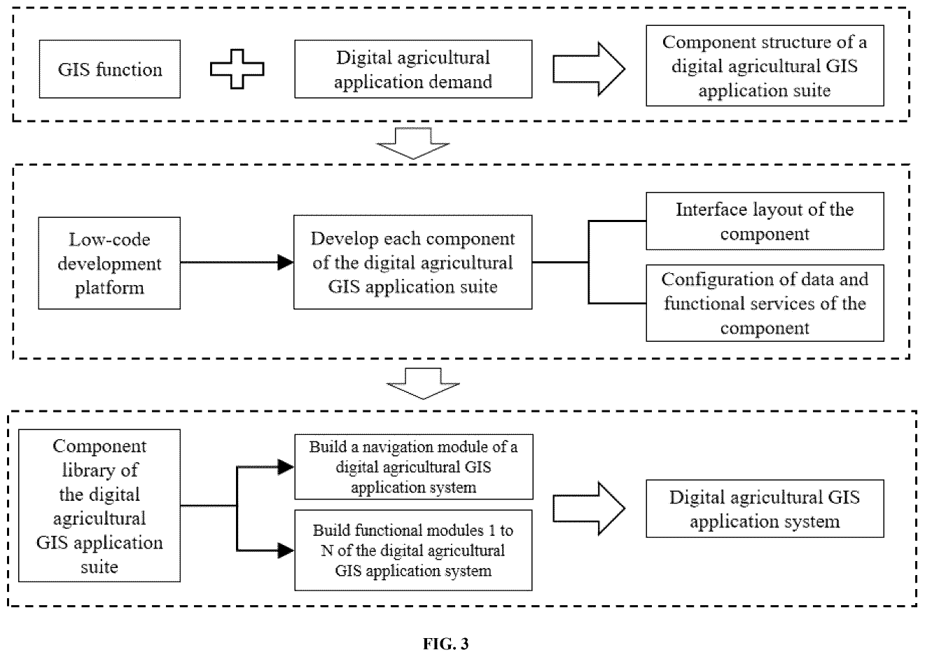

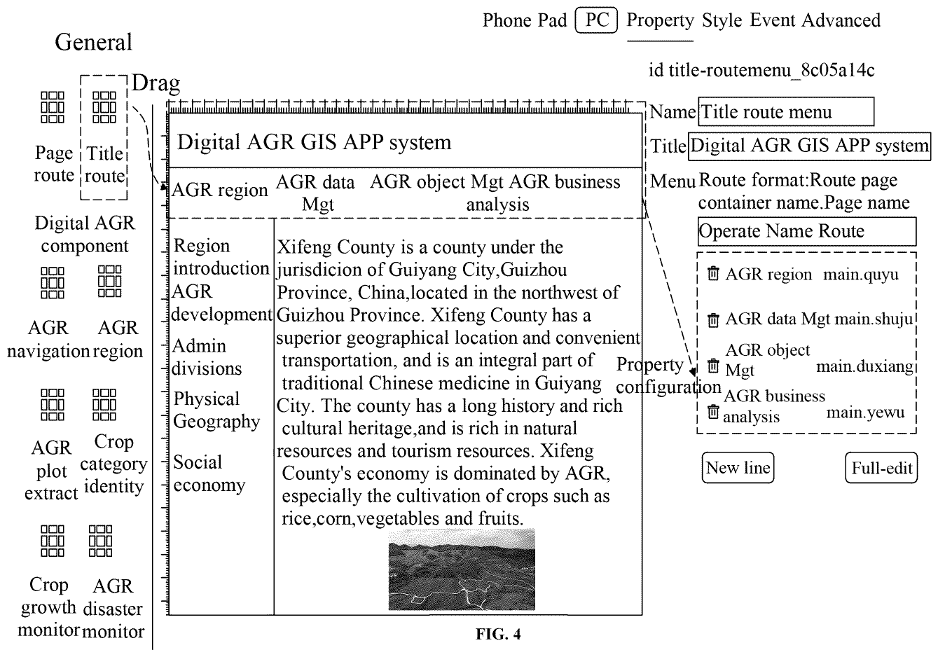

In specific implementation, as shown in FIG. 3, the following steps are included:
(1) Create a blank page canvas as an initial page named “page_index”, drag a “Title route menu” component to the canvas, and configure content of a navigation bar and a route format for the “Title route menu” component in a configuration item of the “Title route menu” component. In this example, a total of six modules are built: “Agricultural regional situation”, “Agricultural data management”, “Agricultural object management”, “Agricultural business analysis”, “Agricultural thematic map”, and “Agricultural decision analysis”. Taking the “Agricultural regional situation” module as an example, “Agricultural regional situation” is input in a “Name” form bar, and “main.qingkuang” is input in a “Route” form bar. The previous step is repeated for remaining modules, as shown in FIG. 4.
(2) On a “Title route menu” page, concatenate a “Page route container” component and the “Title route menu” component, adjust sizes of the two components to an appropriate ratio, and configure a route name of the “Page route container” as “Page container name” based on the route format in the previous step.
(3) Create a blank page canvas, and configure a route name of the page as “Page name” based on the route format in the step (1). The blank page canvas serves as a routing direction of a navigation button and is equipped with one or more digital agriculture components to achieve a function of a system module.
(4) Perform a drag operation on the blank page canvas where the route name has been configured in the step (3) to implement a digital agriculture component required by a corresponding function, adjust a size of the component to an appropriate display size, and complete a custom form configuration of the component. For a functional module that requires collaboration of a plurality of components, the required components are dragged together onto the canvas, and are adjusted to an appropriate size ratio.
(5) For each functional module in the navigation bar, repeat the step (3) and the step (4) to build a plurality of functional module pages of the system, which form, together with the initial page, the GIS application system for digital agriculture.

In an exemplary embodiment, a computer program product is provided, including a computer program. The computer program is executed by a processor to implement the foregoing method.

Those of ordinary skill in the art may understand that all or some of the procedures in the method of the foregoing embodiments may be implemented by a computer program instructing related hardware. The computer program may be stored in a non-volatile computer-readable storage medium. When the computer program is executed, the procedures in the embodiments of the foregoing method may be performed. Any reference to a memory, a database, or other media used in the embodiments of the present disclosure may include a non-volatile and/or a volatile memory.

The technical characteristics of the foregoing embodiments can be employed in arbitrary combinations. To provide a concise description of these embodiments, all possible combinations of all the technical characteristics of the above embodiments may not be described; however, these combinations of the technical characteristics should be construed as falling within the scope defined by the specification as long as no contradiction occurs.

Several examples are used herein for illustration of the principles and implementations of the present disclosure. The description of the foregoing embodiments is used to help illustrate the method of the present disclosure and the core principles thereof. In addition, those of ordinary skill in the art can make various modifications in terms of specific implementations and scope of application in accordance with the teachings of the present disclosure. In conclusion, the content of the specification shall not be construed as a limitation to the present disclosure.

What is claimed is:

1. A method for constructing a geographic information system (GIS) application system for digital agriculture, comprising:
integrating a GIS function with a digital agriculture application demand, and dividing a GIS application for digital agriculture into a plurality of components based on an integration relationship, wherein the GIS function comprises a spatial data management function, a spatial analysis function, a visualization function, a multi-granularity spatio-temporal object management function, a geographic knowledge graph function, and a geographic model analysis function; the digital agriculture application demand comprises an agricultural data management application demand, an agricultural information query application demand, an agricultural knowledge browsing application demand, an agricultural dynamic monitoring application demand, an agricultural statistical analysis application demand, and an agricultural decision support application demand; and the components comprise a general basic component and a business component;
developing the components separately and constructing a digital agricultural GIS application component library; and
selecting a component from the digital agricultural GIS application component library for assembling, and building a navigation module and various functional modules for the GIS application system for digital agriculture to complete construction of the GIS application system for digital agriculture.

2. The method for constructing a GIS application system for digital agriculture according to claim 1, wherein the integrating a GIS function with a digital agriculture application demand specifically comprises:
integrating the spatial data management function with the agricultural data management application demand to manage agricultural regional overview data, agricultural basic geographic data, agricultural thematic data, and agricultural regional socio-economic data by using a spatial database technology;
integrating the spatial data management function with the agricultural information query application demand to spatially query agricultural information by using the spatial database technology;
integrating the spatial data management function with the agricultural knowledge browsing application demand to manage agricultural spatial knowledge by using the spatial database technology;
integrating the spatial data management function with the agricultural statistical analysis application demand to achieve chart statistics of agricultural thematic information;
integrating the spatial analysis function with the agricultural decision support application demand to achieve farmland plot measurement, land planting suitability assessment, and land use planning;
integrating the visualization function with the agricultural statistical analysis application demand to make and display an agricultural thematic map;
integrating the visualization function with the agricultural information query application demand to display a planting region and a growth situation of a crop, thereby displaying a three-dimensional agricultural scene;
integrating the multi-granularity spatio-temporal object management function with the agricultural information query application demand to perform entity management on an administrative region, the planting region, a plot, and the crop, construct a digital agricultural multi-granularity spatio-temporal object, and achieve agricultural object recognition and agricultural object information query;
integrating the geographic knowledge graph function with the agricultural knowledge browsing application demand to construct and display an agricultural knowledge graph;
integrating the geographic knowledge graph function with the agricultural decision support application demand to achieve agricultural assessment and decision-making comprising crop planting adaptation assessment;
integrating the geographic model analysis function with the agricultural dynamic monitoring application demand to achieve crop parameter inversion, crop growth monitoring, and agricultural disaster monitoring; and
integrating the geographic model analysis function with the agricultural decision support application demand to achieve agricultural plot extraction, agricultural crop recognition, and planting suitability assessment.

3. The method for constructing a GIS application system for digital agriculture according to claim 1, wherein the dividing a GIS application for digital agriculture into a plurality of components based on an integration relationship specifically comprises:
constructing the general basic component, wherein a construction process is as follows:
constructing a page route container component and a page title menu component, wherein the page route container component is configured to display page content of the component and configure a route name; and the page title menu component is configured to dynamically switch content in a page route container; and
constructing the business component, wherein a construction process is as follows:
integrating the spatial data management function with the agricultural data management application demand to obtain an agricultural regional overview component and an agricultural data management component through the division;
integrating the spatial data management function with the agricultural information query application demand to obtain an agricultural spatial query component through the division;
integrating with the spatial data management function with the agricultural knowledge browsing application demand to obtain an agricultural geographic knowledge management component through the division;
integrating the spatial analysis function with the agricultural statistical analysis application demand to obtain an agricultural spatial analysis component through the division;
integrating the spatial analysis function with the agricultural decision support application demand to obtain an agricultural spatial decision support component through the division;
integrating the visualization function with the agricultural information management application demand to obtain an agricultural regional location map component and an agricultural three-dimensional scene component through the division;
integrating the visualization function with the agricultural statistical analysis application demand to obtain an agricultural thematic map component through the division;
integrating the multi-granularity spatio-temporal object management function with the agricultural information query application demand to obtain an agricultural object space component and an agricultural object recognition component through the division;
integrating the geographic knowledge graph function with agricultural knowledge browsing application demand to obtain an agricultural geographic knowledge graph component through the division;
integrating the geographic model analysis function with the agricultural dynamic monitoring application demand to obtain an agricultural parameter inversion component, a crop growth monitoring component, an agricultural disaster monitoring component, and a crop yield estimation component through the division; and
integrating the geographic model analysis function with the agricultural decision support application demand to obtain an agricultural plot extraction component, a crop type recognition component, and a planting suitability assessment component through the division.

4. The method for constructing a GIS application system for digital agriculture according to claim 1, wherein the developing the components separately and constructing a digital agricultural GIS application component library specifically comprises:
researching and developing the components through front-end secondary encapsulation, and constructing the digital agricultural GIS application component library, wherein the researching and developing comprise encapsulating and combining interface elements in a front-end UI library, a chart JavaScript library, and a map JavaScript library, and configuring properties of the components and Web services required by the components.

5. The method for constructing a GIS application system for digital agriculture according to claim 1, wherein the building a navigation module of a GIS application system for digital agriculture specifically comprises: building a title route menu and a page route container, which comprises:
establishing a blank page canvas as an initial page, dragging a title route menu component to the initial page, and inputting a navigation bar menu item and a route relationship in a configuration item of the title route menu component, wherein the route relationship is a relationship among the navigation bar menu item, a functional page display container, and a functional page; and
on an initial page of the title route menu, combining the title route menu component and a page route container component, and inputting a corresponding container name in a configuration form of the page route container component based on the configured route relationship.

6. The method for constructing a GIS application system for digital agriculture according to claim 5, wherein the building various functional modules of a GIS application system for digital agriculture specifically comprises:
creating a blank page canvas one by one based on a quantity of the functional modules, and inputting a page name in the route relationship in a page configuration form; and
dragging a digital agriculture component of a corresponding function based on a function implementation requirement of the functional module, wherein the digital agriculture component is the business component.
